(19) United States
(12) Patent Application Publication
(10) Pub. No.: US 2005/0081334 A1
(43) Pub. Date: Apr. 21, 2005

(54) Hinge structure

(76) Inventor: Wen Hao Tai, Hsinchuang City (TW)

Correspondence Address: TROXELL LAW OFFICE PLLC, SUITE 1404, 5205 LEESBURG PIKE, FALLS CHURCH, VA, 22041, US

(21) Appl. No.: 10/684,478

(22) Filed: Oct. 15, 2003

(51) Int. Cl. E05D 11/08

(52) U.S. Cl. 16/339

(57) ABSTRACT

A hinge structure includes a pivot shaft, a bracket, a fastening member, and at least one internally toothed clamp ring located between the pivot shaft and the bracket. The bracket and the clamp rings are sequentially mounted on the pivot shaft and the fastening member is screwed to a tightening section at an end of the pivot shaft. The pivot shaft and a mounting arm on the bracket are separately connected to a mainframe and a screen of a clam-type electronic apparatus, such as a notebook computer. The teeth of the clamp rings would firmly engage with and grip at an outer surface of the pivot shaft to prevent the fastening member from turning along with the screen when the latter is pivotally turned relative to the mainframe. Therefore the fastening member would not separate from the pivot shaft after the screen has been pivotally turned many times.

### FIELD OF THE INVENTION

The present invention relates to a hinge structure, and more particularly to a hinge structure suitable for use with a clam-type electronic apparatus, such as a notebook computer.

### BACKGROUND OF THE INVENTION

A problem generally encountered by a notebook computer user is the screen of the notebook computer tends to become loose and could not be pivotally turned and located at a desired angular position relative to the mainframe for viewing comfortably when the notebook computer has been used for a period of time.

It is therefore tried by the inventor to develop an improved hinge structure for the notebook computer to reduce the rate of failure and the manufacturing cost thereof.

### SUMMARY OF THE INVENTION

A primary object of the present invention is to provide a hinge structure for pivotally turnably connecting two parts of a clam-type electronic apparatus, such as the screen and the mainframe of a notebook computer, so that the clam-type electronic apparatus has lowered rate of failure and manufacturing cost.

The hinge structure for a clam-type electronic apparatus, such as a notebook computer, according to the present invention mainly includes a pivot shaft, a bracket, a fastening member, and at least one internally toothed clamp ring located between the pivot shaft and the bracket.

The bracket and the clamp rings are sequentially mounted on the pivot shaft and the fastening member is screwed to a tightening section at an end of the pivot shaft. The pivot shaft and a mounting arm on the bracket are separately connected to the mainframe and the screen of the notebook computer. The teeth of the clamp rings would firmly engage with and grip at an outer surface of the pivot shaft to prevent the fastening member from turning along with the screen when the latter is pivotally turned relative to the mainframe. Therefore, the fastening member would not separate from the pivot shaft after the screen has been pivotally turned many times.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a hinge structure according to a first embodiment of the present invention;

FIG. 2 is an assembled perspective view of FIG. 1;

FIG. 3 is a fragmentary exploded perspective view of a hinge structure according to a variant of the first embodiment of the present invention;

FIG. 4 is an exploded perspective view of a hinge structure according to a second embodiment of the present invention;

FIG. 5 is an assembled perspective view of FIG. 4;

FIG. 6 is an exploded perspective view of a hinge structure according to a third embodiment of the present invention;

FIG. 7 is an assembled perspective view of FIG. 6;

FIG. 8 is an exploded perspective view of a hinge structure according to a fourth embodiment of the present invention; and

FIG. 9 is an assembled perspective view of FIG. 8.

### DETAILED DESCRIPTION OF THE PREFERRED EMBODIMENTS

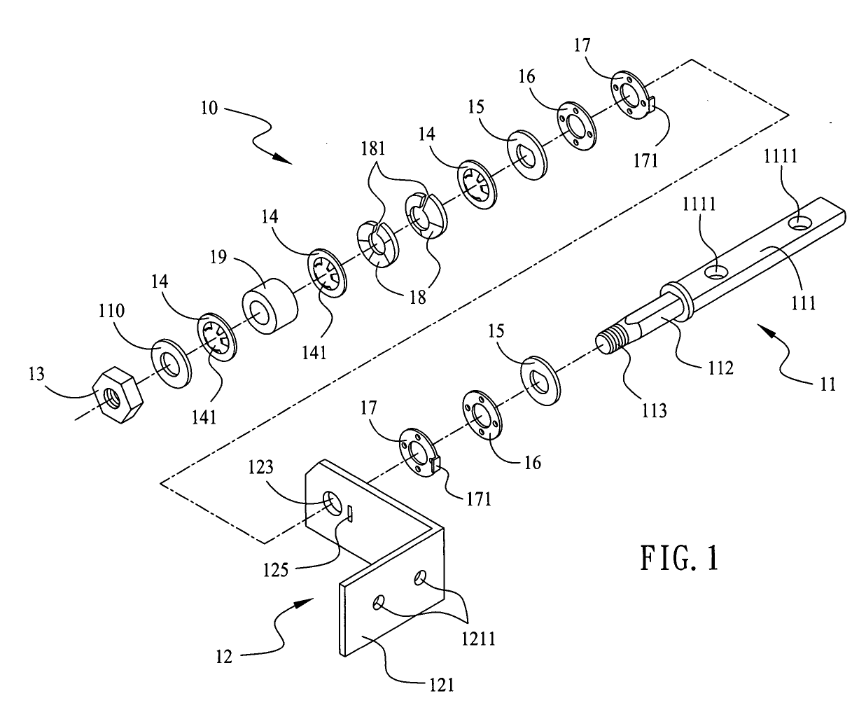

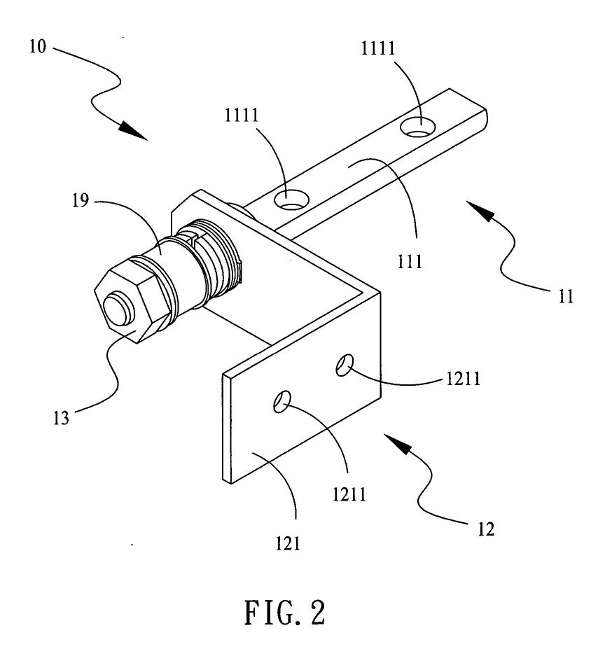

Please refer to FIGS. 1 and 2 that are exploded and assembled perspective views, respectively, of a hinge structure 10 according to a first embodiment of the present invention for mounting between two oppositely movable parts of a clam-type electronic apparatus, such as between a screen and a mainframe of a notebook computer, so that the two parts of the clam-type electronic apparatus may be pivotally turned about the hinge structure relative to each other. As shown in FIGS. 1 and 2, the hinge structure 10 mainly includes a pivot shaft 11, a bracket 12, a fastening member 13, and at least one internally toothed clamp ring 14 located between the bracket 12 and the fastening member 13.

The pivot shaft 11 is provided at a first end with a mounting section 111 for connecting to a first part of the clam-type electronic apparatus, such as the mainframe of the notebook computer (not shown), and at a second end with a shaft section 112 having a tightening section 113 provided at a free end thereof.

The bracket 12 is an L-shaped member having a first arm serving as a mounting arm 121 for connecting to a second part of the clam-type electronic apparatus, such as a screen of a notebook (not shown); and a second arm normal to the first arm. The second arm of the bracket 12 is provided at a predetermined position with a shaft hole 123 for rotatably engaging with the shaft section 112 of the pivot shaft 11.

The internally toothed clamp ring 14 is provided along an inner circumference with a plurality of radially inward projected teeth 141. After the bracket 12 and the at least one clamp ring 14 are sequentially mounted on the pivot shaft 11 and the fastening member 13 is screwed to the tightening section 113 at the second end of the pivot shaft 11, the hinge structure 10 is primarily formed. When the mounting section 111 of the pivot shaft 11 and the mounting arm 121 of the bracket 12 are separately connected to the two parts of the clam-type electronic apparatus, such as the screen and the mainframe of the notebook, the teeth 141 of the internally toothed clamp rings 14 would firmly engage with and grip at an outer surface of the shaft section 112 of the pivot shaft 11. In this manner, turning of the screen would not bring the fastening member 13 to turn at the same time, therefore the fastening member 13 would not separate from the pivot shaft 11 after the screen has been pivotally turned many times.

In the first embodiment shown in FIGS. 1 and 2, there are still a locating ring 15, an oil ring 16, and a lugged ring 17 provided between the pivot shaft 11 and the second arm of the bracket 12, and a lugged ring 17, an oil ring 16, and a locating ring 15 provided between the second arm of the bracket 12 and the internally toothed clamp ring 14. Each of the lugged rings 17 is provided on a circumference thereof with a lug 171 that is axially extended toward one side to be perpendicular to the ring 17. And, the bracket 12 is formed on the second arm to an inner side of the shaft hole 123 with a receiving hole 125 corresponding to the lug 171 on the lugged ring 17. The two lugged rings 17 are separately located at two opposite sides of the shaft hole 123 on the second arm of the bracket 12 with the lugs 171 extended into the receiving hole 125 from two opposite sides thereof.

In the embodiment shown in FIGS. 1 and 2, there are still at least one slit conical washer 18, a sleeve 19, and a flat washer 110 located between the at least one internally toothed clamp ring 14. The slit conical washer 18 is generally a non-closed spiral member and defines a slit 181 between two free ends thereof. The slit conical washer 18 has an outer surface downward and outward inclined from an inner diameter toward an outer diameter thereof to provide a taper, so that the slit conical washer 18 may endure a relatively large compressive force. The slit conical washer 18 also provides an axial elastic force against other components, including the clamp ring 14, the locating ring 15, the oil ring 16, the lugged ring 17, etc., that are put on the shaft section 112 of the pivot shaft 11, so that these components elastically and tightly bear against one another. The elastic force applied by the slit conic washer 18 to other components may be regulated via an extent by which the fastening member 13 is tightened to the tightening section 113 of the pivot shaft 11. The elastic force provided by the slit conic washer 18 may therefore be used to control the tightness by which the bracket 12 is pivotally connected to the pivot shaft 11. When the fastening member 13 is screwed onto the tightening section 113 toward the shaft section 112, the at least one slit conic washer 18 is subject to a compressive force and thereby pushes other components on the shaft section 112 and brings the same to tightly bear against one another, resulting in an increased frictional force between these components. On the other hand, when the fastening member 13 is turned away from the shaft section 112, the slit conic washer 18 is released from the compressive force to result in a decreased resistance to the turning of the pivot shaft 11 relative to the bracket 12.

The mounting section 111 of the pivot shaft 11 is provided with at least one mounting holes 1111, via which the pivot shaft 11 is mounted to the first part of clam-type electronic apparatus, such as the mainframe of a notebook computer. The tightening section 113 is provided on an outer surface with screw threads, and the fastening member 13 may be a nut corresponding to the screw threads on the tightening section 113, so that the fastening member 13 may be screwed to the tightening section 113.

The mounting arm 121 of the bracket 12 is provided with at least one mounting hole 1211, via which the bracket 12 is mounted to the second part of the clam-type electronic apparatus, such as the screen of a notebook computer.

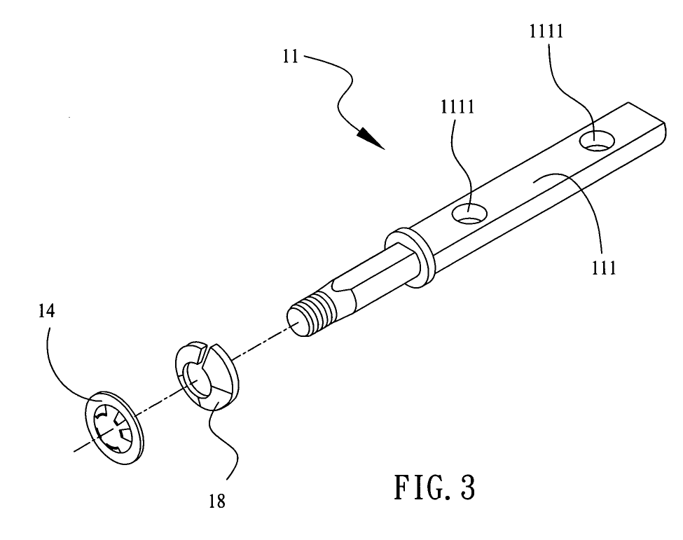

Please refer to FIG. 3. In a variant of the above-described first embodiment of the present invention, at least one internally toothed clamp ring 14 and at least one slit conic washer 18 are provided between the pivot shaft 11 and the bracket 12.

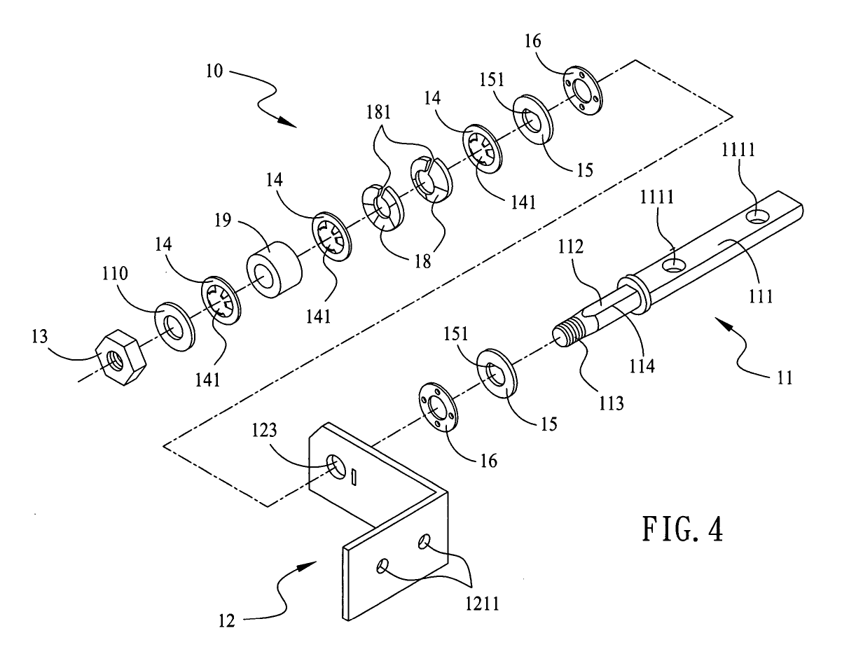

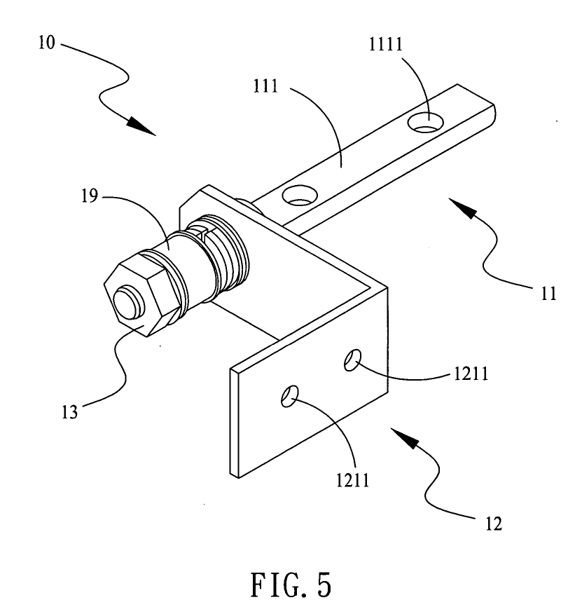

FIGS. 4 and 5 are exploded and assembled perspective views, respectively, of a hinge structure according to a second embodiment of the present invention. In the second embodiment, the shaft section 112 of the pivot shaft 11 is provided with a swing-stop section 114, which includes a flat surface, only a locating ring 15 and an oil ring 16 are provided between the pivot shaft 11 and the bracket 12, and only an oil ring 16 and a locating ring 15 are provided between the at least one internally toothed clamp ring 14 and the bracket 12. The locating ring 15 is provided on an inner circumferential edge with a straight section 151 corresponding to the swing-stop section 114 on the shaft section 112. The locating ring 15 is mounted on the shaft section 112 with the straight section 151 bearing against the flat surface of the swing-stop section 114, enabling the locating ring 15 to locate on the pivot shaft 11 without turning relative to the shaft section 112.

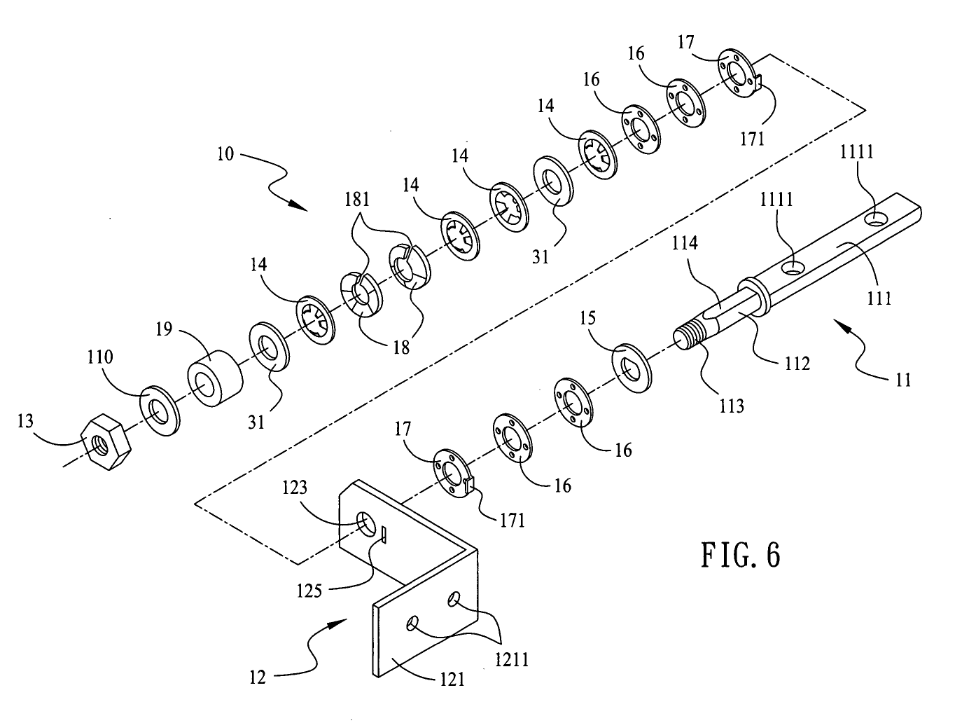

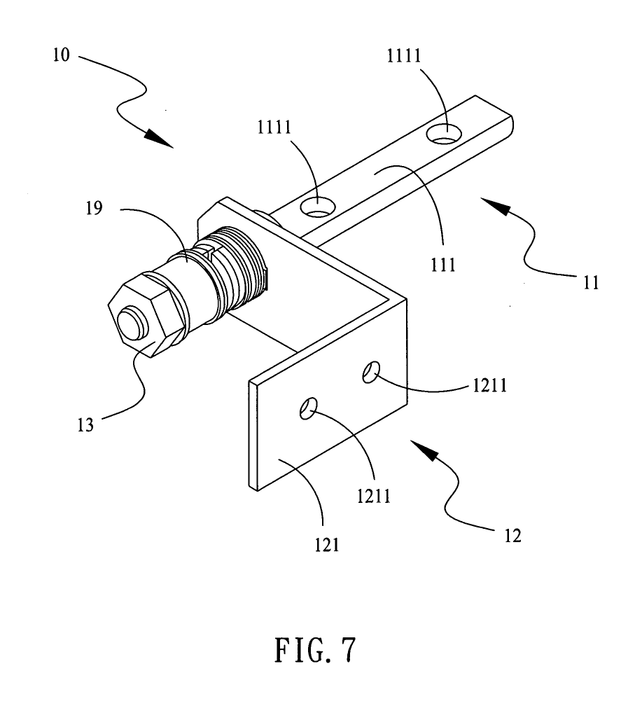

FIGS. 6 and 7 are exploded and assembled perspective views, respectively, of a hinge structure according to a third embodiment of the present invention. In the third embodiment, the shaft section 112 is provided with a swing-stop section 114, which includes a flat surface; a locating ring 15, at least one oil ring 16, and a lugged ring 17 are provided between the pivot shaft 11 and the bracket 12; and a lugged ring 17, at least one oil ring 16, and a flat washer 31 are provided between the bracket 12 and the at least one internally toothed clamp ring 14. Each of the lugged rings 17 is provided on a circumference thereof with a lug 171 that is axially extended toward one side to be perpendicular to the ring 17. And, the bracket 12 is formed on the second arm to an inner side of the shaft hole 123 with a receiving hole 125 corresponding to the lug 171 on the lugged ring 17. The two lugged rings 17 are separately located at two opposite sides of the shaft hole 123 on the second arm of the bracket 12 with the lugs 171 extended into the receiving hole 125 from two opposite sides thereof. The locating ring 15 is provided on an inner circumferential edge with a straight section 151 corresponding to the flat surface of the swing-stop section 114 on the shaft section 112. The locating ring 15 is mounted on the shaft section 112 with the straight section 151 bearing against the flat surface of the swing-stop section 114, enabling the locating ring 15 to locate on the pivot shaft 11 without turning relative to the shaft section 112.

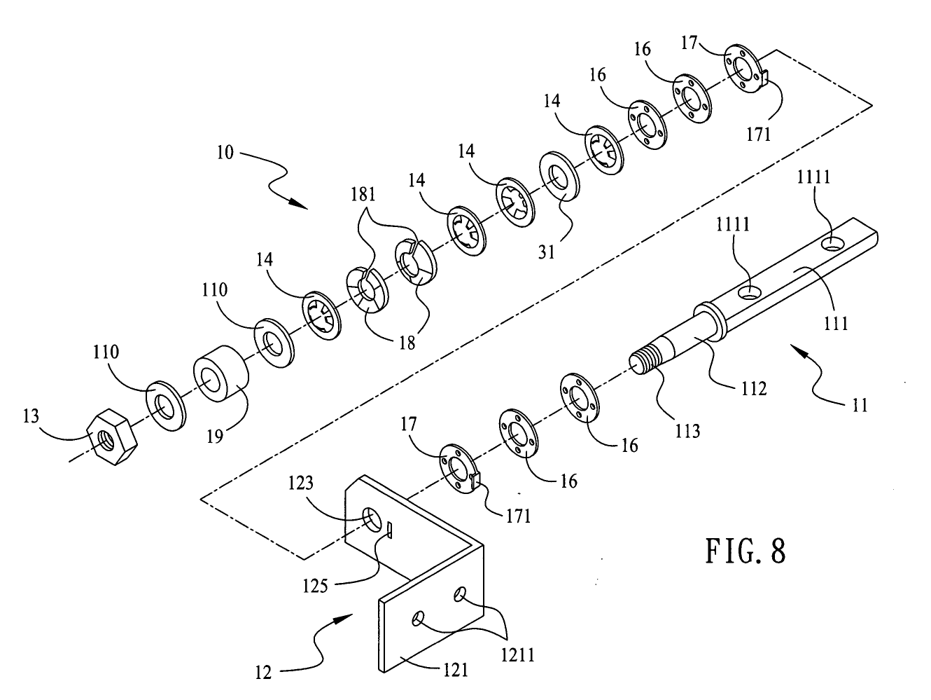

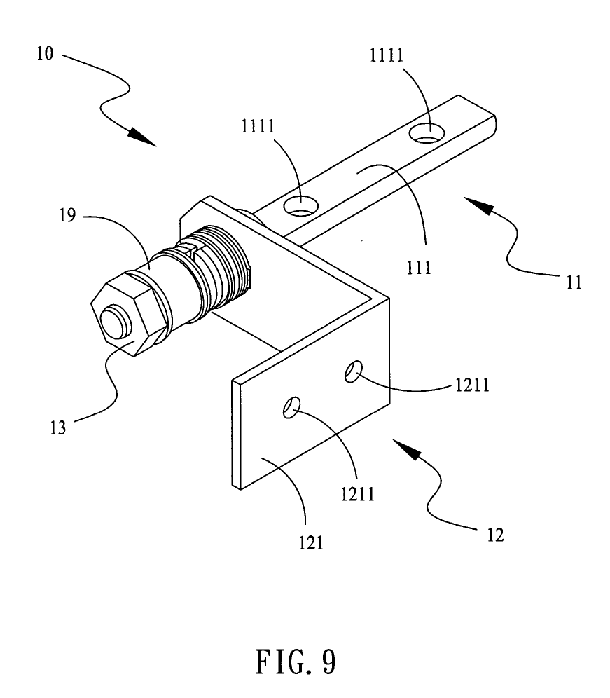

Please refer to FIGS. 8 and 9 that are exploded and assembled perspective views, respectively, of a hinge structure according to a fourth embodiment of the present invention. In the fourth embodiment, there is at least one oil ring 26 and a lugged ring 17 provided between the pivot shaft 11 and the bracket 12; and a lugged ring 17 and at least one oil ring 16 provided between the bracket 12 and the at least one internally toothed clamp ring 14. Each of the lugged rings 17 is provided on a circumference thereof with a lug 171 that is axially extended toward one side to be perpendicular to the ring 17. And, the bracket 12 is formed on the second arm to an inner side of the shaft hole 123 with a receiving hole 125 corresponding to the lug 171 on the lugged ring 17. The two lugged rings 17 are separately located at two opposite sides of the shaft hole 123 on the second arm of the bracket 12 with the lugs 171 extended into the receiving hole 125 from two opposite sides thereof. And, there is a flat washer 110 provided between the at least one internally toothed clamp ring 14 and the sleeve 19.

The present invention has been described with some preferred embodiments thereof and it is understood that many changes and modifications in the described embodiments can be carried out without departing from the scope and the spirit of the invention that is intended to be limited only by the appended claims.

1. A hinge structure, comprising:
a pivot shaft being provided at a first end with a mounting section for connecting to a mainframe of a clam-type electronic apparatus, and at a second end with a shaft section having a tightening section provided at a free end thereof;
a bracket that is an L-shaped member having a first arm serving as a mounting arm for connecting to a screen of said clam-type electronic apparatus, and a second arm normal to said first arm; said second arm being provided at a predetermined position with a shaft hole for rotatably engaging with said shaft section of said pivot shaft;
a fastening member; and
at least one internally toothed clamp ring located between said bracket and said fastening member, and provided along an inner circumferential edge with a plurality of radially inward projected teeth;
said bracket and said at least one internally toothed clamp ring being sequentially mounted on said pivot shaft and said fastening member being screwed to said tightening section at the second end of said pivot shaft to form said hinge structure; said mounting section of said pivot shaft and said
mounting arm of said bracket being connected to said mainframe and said screen, respectively, of said clam-type electronic apparatus;
said teeth of said at least one internally toothed clamp ring being adapted to firmly engage with and grip at an outer surface of said shaft section of said pivot shaft, and thereby preventing said fastening member from turning along with said screen when said screen is pivotally turned, ensuring said fastening member is not separated from said pivot shaft after said screen has been pivotally turned many times.

2. The hinge structure as claimed in claim 1, further comprising a locating ring, an oil ring, and a lugged ring provided between said pivot shaft and said second arm of said bracket; and a lugged ring, an oil ring, and a locating ring provided between said second arm of said bracket and said at least one internally toothed clamp ring; each of said lugged rings being provided on a circumference thereof with a lug that is axially extended toward one side to be perpendicular to said lugged ring; and said bracket being formed on said second arm to an inner side of said shaft hole with a receiving hole corresponding to said lug on said lugged ring, such that said two lugged rings are separately located at two opposite sides of said shaft hole on said second arm of said bracket with said lugs extended into said receiving hole from two opposite sides of said receiving hole.

3. The hinge structure as claimed in claim 1, further comprising at least one slit conical washer, a sleeve, and a flat washer located between said at least one internally toothed clamp ring; each of said slit conical washers being a non-closed spiral member and defines a slit between two free ends thereof; said slit conical washer having an outer surface downward and outward inclined from an inner diameter toward an outer diameter thereof to provide a taper, so that said slit conical washer may endure a relatively large compressive force; and said slit conical washer also providing an axial elastic force against other components put on said shaft section of said pivot shaft, so that said other components elastically and tightly bear against one another; and said elastic force applied by said slit conic washer to said other components being adjustable by tightening said fastening member to said tightening section of said pivot shaft by different degree, and therefore being usable in controlling the tightness by which said bracket is pivotally connected to said pivot shaft.

4. The hinge structure as claimed in claim 1, wherein said mounting section on said pivot shaft is provided with at least one mounting hole, via which said pivot shaft is connected to said mainframe of said clam-type electronic apparatus.

5. The hinge structure as claimed in claim 1, wherein said tightening section on said pivot shaft is provided on an outer surface with screw threads, and said fastening member is a nut corresponding to said screw threads for said fastening member to screw to said tightening section.

6. The hinge structure as claimed in claim 1, wherein said mounting arm of said bracket is provided with at least one mounting hole, via which said bracket is connected to said screen of said clam-type electronic apparatus.

7. The hinge structure as claimed in claim 1, wherein said shaft section of said pivot shaft is provided with a swing-stop section, which includes a flat surface; and wherein a locating ring and an oil ring are provided between said pivot shaft and said bracket, and an oil ring and a locating ring are provided between said bracket and said at least one internally toothed clamp ring; said locating ring being provided on an inner circumferential edge with a straight section corresponding to said flat surface of said swing-stop section on said shaft section, such that said locating ring is mounted on said shaft section with said straight section bearing against said flat surface of said swing-stop section, enabling said locating ring to locate on said pivot shaft without turning relative to said shaft section.

8. The hinge structure as claimed in claim 1, wherein said shaft section is provided with a swing-stop section, which includes a flat surface; and wherein a locating ring, at least one oil ring, and a lugged ring are provided between said pivot shaft and said bracket; and a lugged ring, at least one oil ring, and a flat washer are provided between said bracket and said at least one internally toothed clamp ring; each of said lugged rings being provided on a circumference thereof with a lug that is axially extended toward one side to be perpendicular to said ring; and said bracket being formed on the second arm to an inner side of said shaft hole with a receiving hole corresponding to said lug on said lugged ring, said two lugged rings being separately located at two opposite sides of said shaft hole on said second arm of said bracket with said lugs extended into said receiving hole from two opposite sides thereof; and said locating ring is provided on an inner circumferential edge with a straight section corresponding to said flat surface of said swing-stop section on said shaft section, said locating ring being mounted on said shaft section with said straight section bearing against said flat surface of said swing-stop section, enabling said locating ring to locate on said pivot shaft without turning relative to said shaft section.

9. The hinge structure as claimed in claim 1, wherein said clam-type electronic apparatus is a notebook computer.
